(19) United States
(12) Patent Application Publication
(10) Pub. No.: US 2023/0334575 A1
(43) Pub. Date: Oct. 19, 2023

(54) INTELLECTUAL PROPERTY PORTFOLIO BUDGETING TOOL

(71) Applicant: Black Hills IP Holdings, LLC, Minneapolis, MN (US)

(72) Inventor: Steven W. Lundberg, Edina, MN (US)

(21) Appl. No.: 18/122,875

(22) Filed: Mar. 17, 2023

Related U.S. Application Data
(60) Provisional application No. 63/332,257, filed on Apr. 18, 2022.

(51) Int. Cl. G06Q 40/06; G06Q 50/18

(52) U.S. Cl. CPC G06Q 40/06; G06Q 50/184

(57) ABSTRACT

Various embodiments disclosed relate to systems and methods for budgeting for patent portfolios. The present disclosure includes automated, computer implemented methods of dynamically budgeting for patent portfolio annuities. Methods can include receiving an intellectual property portfolio comprising one or more patent documents, aggregating upcoming costs associated with each of the patent documents to produce a preliminary budgeting report, and dynamically filtering the aggregated costs in the preliminary budgeting report based on one or more parameters. A budgeting projection can be produced based on the dynamically filtered aggregated costs.

### CLAIM OF PRIORITY

This application claims the benefit of priority under 35 U.S.C. § 119(e) to U.S. Provisional Patent Application Ser. No. 63/332,257, filed on Apr. 18, 2022, and which is incorporated by reference herein in its entirety.

### BACKGROUND

Companies often file for and hold a variety of intellectual property rights, such as copyrights, trademarks, and patents, depending on their business purpose and goals. Often, such intellectual property matters require maintenance or annuities to maintain actively enforceable intellectual property. Specifically, patents in the U.S., once issued, require annuities to maintain their active status. These costs can accumulate.

### SUMMARY OF THE DISCLOSURE

The present disclosure provides methods and a tool for patent portfolio budgeting. The method can include receiving a patent portfolio, aggregating costs associated with the items in the patent portfolio, such as annuities or maintenance fees, and producing a dynamic budget projection. The user can manipulate the budget projection based on their desired active patent portfolio.

When a company holds a patent portfolio, they are required to pay certain annuities to maintain the active status of the patents in the portfolio. The specifics differ between jurisdictions, depending on the country in which the patent was granted, when the patent was filed, and a variety of other factors. Overall, a company with a large number of patents in their portfolio may be required to pay a large number of annuities varying in amount and timing in order to maintain an active patent portfolio. These annuities can quickly add up, and the deadlines can be logistically challenging to track.

Sometimes, companies desire to keep particular patent or patent families active. For example, where the patent or patent family in questions corresponds to a commercial product that company is producing, the company might prioritize that patent or patent family. However, it may make sense strategically for a company to let a patent lapse by non-payment of annuities, such as if the company has moved in a different direction with its technology and business model. Understanding when annuities are due and in what amounts can help a company many such strategic decisions.

Disclosed here is a patent annuities budgeting tool, which can produce a dynamically updatable budget projection for a patent portfolio. The projection can calculate annuities, and indicate a budget for a given time period, such as a quarter or a year. A user interacting with the tool can selectively add or remove patents or patent families from the projection, and the budgeting tool can dynamically update the projected budget accordingly. This can allow the user to make strategic decisions for which patents or patent families to keep alive with the payment of annuities.

In an example, a method of producing a dynamic budget projection for an intellectual property portfolio can include receiving an intellectual property portfolio comprising one or more patent documents, aggregating upcoming costs associated with each of the patent documents to produce a preliminary budgeting report, dynamically filtering the aggregated costs in the preliminary budgeting report based on one or more parameters, and producing a budgeting projection based on the dynamically filtered aggregated costs.

### BRIEF DESCRIPTION OF THE DRAWINGS

In the drawings, which are not necessarily drawn to scale, like numerals may, describe similar components in different views. Like numerals having different letter suffixes may represent different instances of similar components. The drawings illustrate generally, by way of example, but not by way of limitation, various embodiments discussed in the present document.

FIG. 1 is a schematic diagram of an intellectual property budget management system in an example.

FIG. 2 is a schematic diagram of sources of data used in an intellectual property budget management system in an example.

FIG. 3 is a schematic diagram of a budgeting tool in an example.

FIG. 4 is a flow chart depicting a method of using a budgeting tool to produce a dynamic budget projection in an example.

FIGS. 5A-5F are schematic diagrams of dynamic budget projections in an example.

FIG. 6 illustrates a block diagram of an example computing machine upon which any one or more of the techniques or methodologies discussed herein may be implemented.

### DETAILED DESCRIPTION

The present disclosure describes, among other things, are automated methods for budgeting for intellectual property (IP) portfolios. For example, a user can login to the budgeting tool to see what pending and issued cases are in his portfolio. The budgeting tool can be used to project IP costs for each of the items in the portfolio, such as upcoming annuities for issued cases in a specified time period, such as a quarter or a year; or upcoming annuities for issued cases in a given country. The budgeting tool can be leveraged to show various scenarios, such as the difference in cost projection if particular cases are allowed to lapse.

As used herein, “accounting system,” or “accounting database” refers to an accounting or financial system for receiving and processing annuities or maintenance fees for an intellectual property portfolio.

As used herein, “application” or “program” can include a program or piece of software designed and written to fulfill a particular purpose of the user, such as a database application.

As used herein, “associate” can include a partner or colleague in business or at work, either internal or external.

As used herein, “database,” can refer to a structured set of data, such as held in a computer or on the internet, that can be accessible in various ways.

As used herein, “electronic communication” refers to an electronic message or a method of exchanging messages between people using electronic devices.

As used herein, “file” or “matter” can refer to a particular project, enterprise, or undertaking being worked on by an individual or a collaborative group, planned and designed to achieve a particular aim.

As used herein, “invoice,” “bill,” or “tab,” refers to a commercial document issued by a seller to a buyer, relating to a sale transaction and indicating the products, quantities, and agreed prices for products or services the seller had provided the buyer. Payment terms are usually stated on the invoice.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “patent family” can refer to patent filings that are related, such as parent/child, sibling, or other related patent filings according to the rules of the given patent jurisdiction. In some cases, this can include cases that claims priority to another, cases that are continuations or continuations-in-part, or divisional filings.

As used herein, “portfolio,” “intellectual property portfolio,” or “patent portfolio,” can refer to a group of patent filings, such as related patents, patent filings of common ownership, patent filings of common inventorship, or other combinations thereof.

As used herein, “scraping,” “web scraping,” “data scraping,” or “web crawling,” can refer to automatically mining or collecting data or information, such as from a database or from the internet.

As used herein, “structured text” or “structured data” refers to data that is organized in a standard format such that a recipient may read the data and institute an automated computing system action without human interpretation of the data.

As used herein, “unstructured text” or “unstructured data” refers to data that is not organized in a standard format, for example, text in the body of a billing entry,

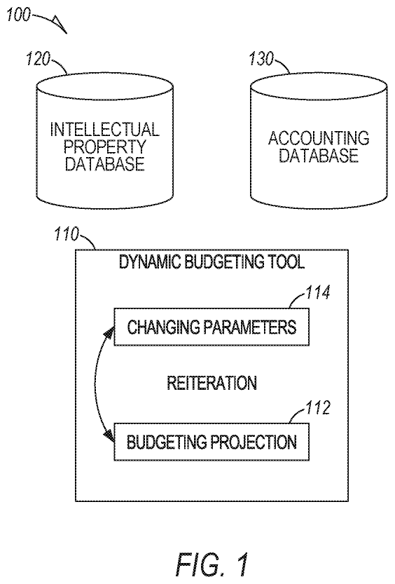

FIG. 1 is a schematic diagram of an intellectual property budget management system 100 in an example. The system 100 can include a dynamic budgeting tool 110 in communication with an intellectual property database 120 and an accounting system 130. Within the dynamic budgeting tool 110, a budget projection 112 and a parameters module 114 can be used.

The intellectual property database 120 can include a repository of files or projects being working on by the company, such as patent documents. The intellectual property database 120 can be, for example, a public or private database. In an example, the USPTO PAIR database can be accessed. In an example, ESPACENET can be accessed. In some cases, other database can be used. In some cases, privately run and updated databases can be accessed.

The intellectual property database 120 can, for example, be an internal docketing system, an external docketing system, an official intellectual property database such as the World Intellectual Property Organization (WIPO) database, a governmental database such as the USPTO, an internal database, or combinations thereof.

The intellectual property database 120 can include information on various files of interest for the business. For example, the intellectual property database 120 can include information about patent applications or trademark applications, Such information can, for example, include communications from a governmental agency, responses filed by the company, and other official documents. The intellectual property database 120 can be in communication with the dynamic budgeting tool 110 to help provide bibliographic information to the dynamic budgeting tool 110 and help provide annuity information such as due dates and amounts.

The intellectual property database 120 can, for example, include a local or cloud-based file storage system including information of files and projects being worked on at or monitored by the company. The intellectual property database 120 can contain historical records, such as past events, communications, and decisions in each file.

The accounting system 130 can, for example, include a database of costs associated with patent portfolio upkeep, and can be in communication with the dynamic budgeting tool 110. The accounting system 130 can help scrap appropriate costs associated with each of the items received from the intellectual property database 120 for the budget projection. In some cases, the accounting system 130 can dynamically update costs. In some cases, the accounting system 130 can provide conversions of costs to different currencies. The accounting system 130 can, for example, include a local or cloud-based file storage system including financial information of intellectual property files and projects being worked on at or monitored by the company.

The dynamic budgeting tool 110 can work in concert with the intellectual property database 120 and the accounting system 130 to collect the relevant data on the intellectual property portfolio of interest and produce a dynamic budget projection for user interaction and review. The dynamic budgeting tool 110 can, for example, receive bibliographic data from the intellectual property database 120 regarding each patent items in the portfolio of interest, such as priority dates, filing dates, expiration dates, and maintenance fee dates. The dynamic budgeting tool 110 can, for example, receive financial data from the dynamic budgeting tool 110 regarding each of the patent items in the portfolio of interest, such as the amount of maintenance fees and the currencies those fees are paid in.

The dynamic budgeting tool 110 can receive an input of various parameters to take into account when producing the budget projection 112. For example, the dynamic budgeting tool 110 can receive a default set of parameters, such as filtering by priority date, expiration date, technology area, inventors, or a variety of other filters. For example, the input can specify a budget projection 112 including only patent items from a specific technology area, such as docketing software patents.

In some cases, a user can interact with the dynamic budgeting tool 110, such as through user interface. The parameters module 114 can be configured to receive these various parameters and produce the budget projection 112.

The dynamic budgeting tool 110 can additionally receive parameters such as a projection timeline, that is, to produce a budget projection 112 over a certain number of months or years. For example, the dynamic budgeting tool 110 can receive an input requesting a budget projection 112 for the calendar year 2024, for the first quarter of 2024, or for a different time period.

When the dynamic budgeting tool 110 receives the parameters, both for types of patent items of interest, and the timeline for the budget projection 112, the dynamic budgeting tool 110 can apply the appropriate financial information, such as the deadlines for annuities and the amounts thereof. The dynamic budgeting tool 110 can use the deadlines and amount of annuities to produce the budget projection 112, which can present to the user, such as on a user interface, a preliminary budget projection for that particular portion of the patent portfolio of interest.

Once the budget projection 112 is produced based on the initial parameters, both for types of patent items, and the total amount of annuities due is produced for user review, the budget projection 112 can be further, dynamically updated. The user can update any of the parameters to dynamically change the budget projection 112.

Moreover, the user can select one or more patent items in the budget projection 112 to add or remove that specific patent item to the projection 112. For example, if patents A, B, and C are in the initial projection for the next quarter, and the amount of the budget projection is too high, the user can request the dynamic budgeting tool 110 remove patent B from consideration. The dynamic budgeting tool 110 can selectively remove patent B from the budget projection 112 and revise the financial projection accordingly.

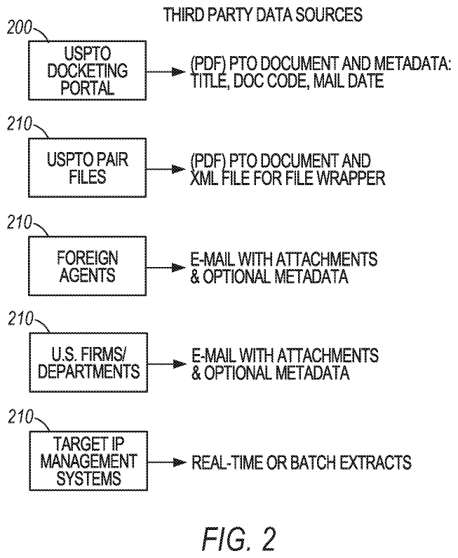

FIG. 2 illustrates sample third party data sources that provide data input for an dynamic budgeting tool 110 implemented for managing patent portfolio annuities in an example. The various third party data sources can be received in the intellectual property database 120, the accounting system 130 and/or directly in the dynamic budgeting tool 110, such as through data scraping, automated transfer, or manual input. As illustrated in FIG. 2, the third party data sources may include the Patent Office (e.g., USPTO) docketing portal 200, which provides documents from the USPTO in portable document format (PDF) and includes metadata identifying the title, document code, and mail date for the corresponding document. The third party data sources may further include USPTO PAIR extensible markup language (XML) files 210, which provide documents from the USPTO in PDF and includes an XML file for patent file wrappers. The third party data sources may also include foreign agents 220 who provide emails with attachments and optional metadata. Foreign agents 220 may also provide hard copy documents that may be scanned for data entry. Similarly, law firms and/or corporate law departments 230 may provide emails with attachments and optional metadata as well as hard copy documents that may be scanned for data entry. Also, third party docketing systems 240 may provide real-time or batch extracts of data for entry into a docketing management system.

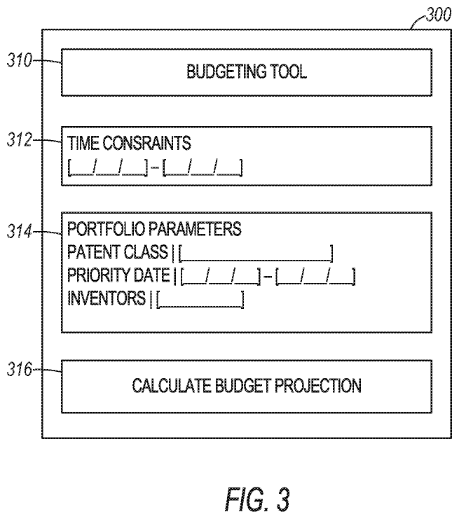

FIG. 3 is a schematic diagram of a budgeting tool 110 user interface 300 in an example. The user interface 300 can include a home banner 310, a field for receiving timeline parameters 312, a field for receiving portfolio parameters 314, and a calculation button 316.

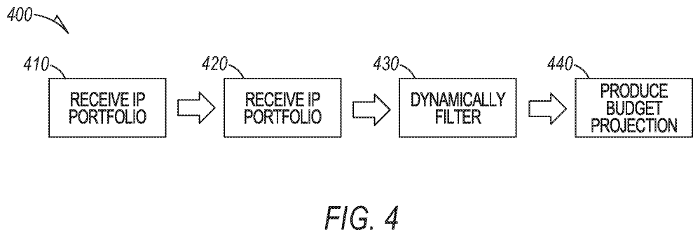

FIG. 4 is a flow chart depicting a method 400 of using a budgeting tool to produce a dynamic budget projection in an example. In the method 400, the budgeting tool can receive an intellectual property portfolio (block 410), aggregate upcoming costs associated with the portfolio (block 420), dynamically filter the costs (block 430), and produce a budget projection accordingly (block 440).

At block 410, the budgeting tool can receive an intellectual property portfolio, for example, from an intellectual property database or docketing system. In some cases, this can be automated or semi-automated. The budgeting tool can, for example, scrape the portfolio data from such a database or system. In some cases, the budgeting tool can filter the receiving portfolio, such as by receipt of parameters limiting the patents analyzed.

At block 420, the budgeting tool can aggregate costs associated with each of the patent items in the receive intellectual property portfolio. For example, the budgeting tool can calculate upcoming annuities or maintenance fees associated with each of the patent items in the intellectual property portfolio over a specified time period. In some cases, the budgeting tool can interact with an accounting database or a financial system to collect the appropriate estimates for costs and to calculate total in the appropriate currency.

At block 430, the budgeting tool can dynamically filter the costs and alter a budgeting projection. For example, the budgeting tool can receive an input that one or more patent documents should be removed from or added to the projection and can add or remove corresponding costs such as annuities or maintenance fees.

At block 440, the budgeting tool can produce a budget projection based on the earlier blocks. In some cases, blocks 430 and 440 can be reiterated, and the budget projection can be dynamically updated.

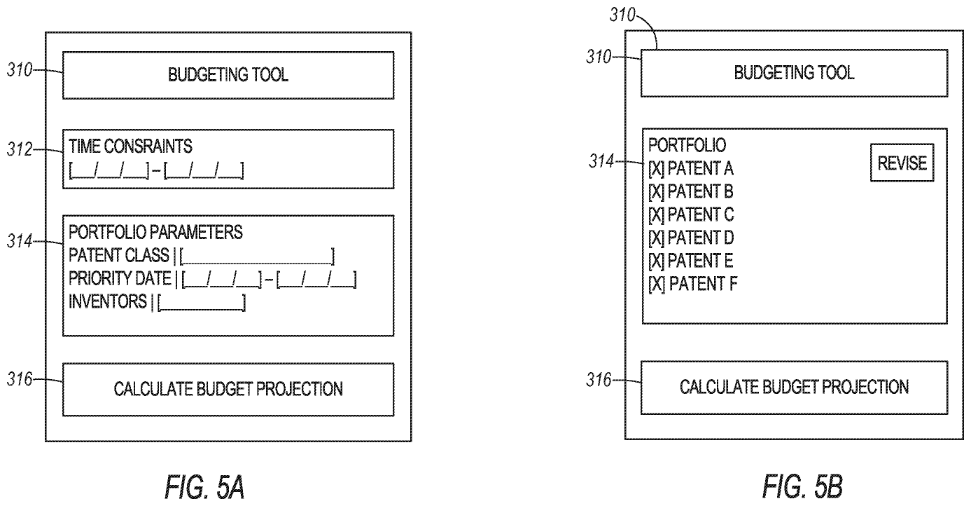

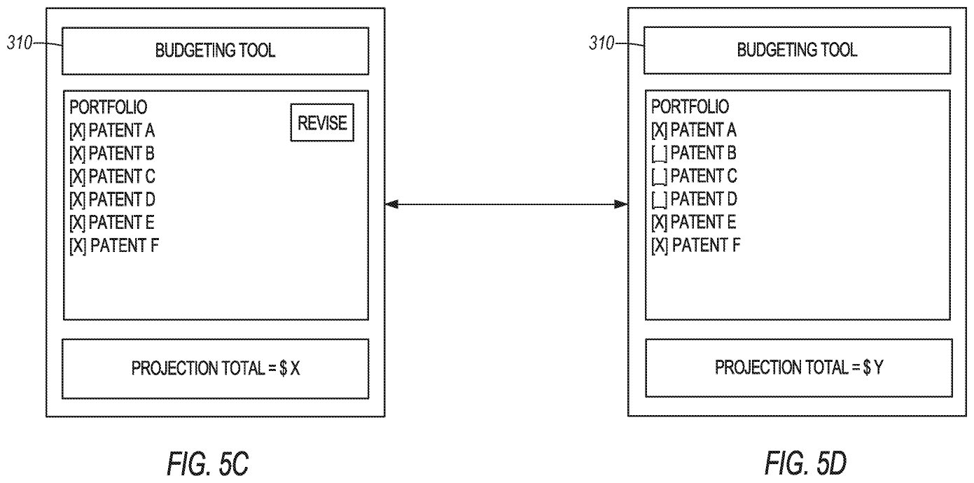

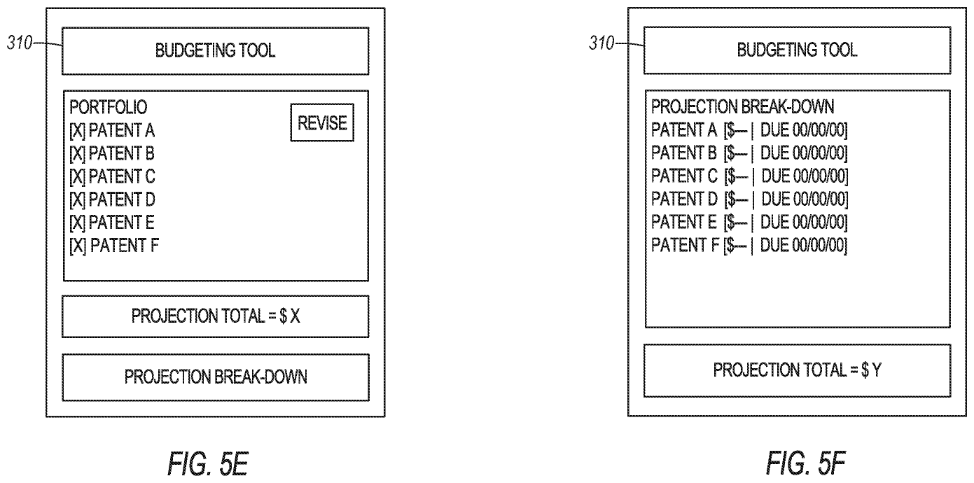

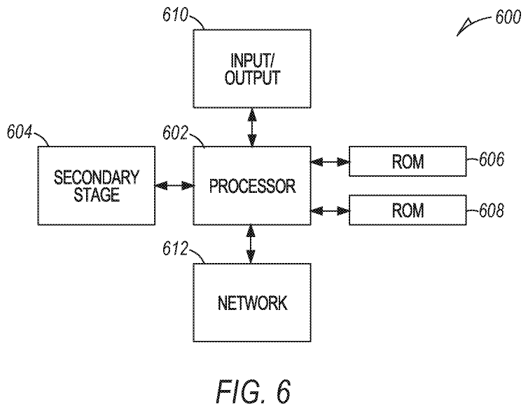

FIGS. 5A-5E are schematic diagrams of dynamic budget projections in an example. In FIG. 5A, a budgeting tool 110 is shown awaiting input. Here, the desired time constraints for the budget projection can be entered. The desired portfolio parameters can also be entered. In some cases, the portfolio can be further filtered, such as by inventors. Other filters can be used as desired. Once the appropriate parameters are entered, the calculation button can be pressed. The budgeting tool 110 can take in the parameters and produce a budget projection as shown in FIG. 5B.

FIGS. 5C and 5D show a dynamically updating budget projection. Here, the original budget projection with the whole portfolio is shown in FIG. 5D, including patents A, B, C, D, E, and F. It may be that the projected total of $ X over the time period is too high. Thus, the user can indicate to the budgeting tool that patents A, E, and F, are of highest priority. The budgeting tool 110 can revise the budgeting projection based on this indication and revise the projection so it reads a cost of $ Y, which may be more acceptable. Such dynamic changes in the budget projection can be reiterated as desired.

FIG. 5E shows a budget projection compared to the break-down of that projection in FIG. 5F. The break-down in FIG. 5F shows what dates each of the individual fees are due for each patent item in the portfolio. This can help the user when analyzing which patents to keep alive through the payments of annuities or maintenance fees.

FIG. 6 illustrates a block diagram of an example computing system machine 600 upon which any one or more of the techniques (e.g., methodologies) discussed herein may perform. Machine 600 (e.g., computer system) may include a hardware processor 602 (e.g., a central processing unit (CPU), a graphics processing unit (GPU), a hardware processor core, or any combination thereof), a main memory 604 and a static memory 606, connected via an interconnect 608 (e.g., link or bus), as some or all of these components may constitute hardware for systems 100 or 200 or hardware to operate the services and subsystems and related implementations discussed above.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage device 616 (e.g., drive unit), a signal generation device 618 (e.g., a speaker), a network interface device 620, and one or more sensors 630, such as a global positioning system (GPS) sensor, compass, accelerometer, or some other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.), In some embodiments the hardware processor 602 and/or instructions 624 may comprise processing circuitry and/or transceiver circuitry.

The mass storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606; or the mass storage device 616 constitutes, in at least some embodiments, machine readable media.

The term “machine readable medium” includes, in some embodiments, any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Specific examples of machine readable media include, one or more of non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks. While the machine readable medium 622 is illustrated as a single medium, the term “machine readable medium” includes, in at least some embodiments, a single medium or multiple media (e.g., a centralized or distributed database, and/or associated caches and servers) configured to store the one or more instructions 624. In some examples, machine readable media includes non-transitory machine readable media. In some examples, machine readable media includes machine readable media that is not a transitory propagating signal.

The instructions 624 are further transmitted or received, in at least some embodiments, over a communications network 626 using a transmission medium via the network interface device 620 utilizing any one of a number of transfer protocols (e.g., frame relay, internet protocol (IP), transmission control protocol (TCP), user datagram protocol (MP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

An apparatus of the machine 600 includes, in at least some embodiments, one or more of a hardware processor 602 (e.g., a central processing unit (CPU), a graphics processing unit (GPU), a hardware processor core, or any combination thereof), a main memory 604 and a static memory 606, sensors 630, network interface device 620, antennas 632, a display device 610, an input device 612, a UI navigation device 614, a mass storage device 616, instructions 624, a signal generation device 618, and an output controller 628. The apparatus is configured, in at least some embodiments, to perform one or more of the methods and/or operations disclosed herein. The apparatus is, in some examples, a component of the machine 600 to perform one or more of the methods and/or operations disclosed herein, and/or to perform a portion of one or more of the methods and/or operations disclosed herein.

In an example embodiment, the network interface device 620 includes one or more physical jacks (e.g., Ethernet, coaxial, or phone jacks) or one or more antennas to connect to the communications network 626. In an example embodiment, the network interface device 620 includes one or more antennas 632 to wirelessly communicate using at least one of single-input multiple-output (SIMO), multiple-input multiple-output (MIMO), or multiple-input single-output (MISO) techniques. In some examples, the network interface device 620 wirelessly communicates using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

At least some example embodiments, as described herein, include, or operate on, logic or a number of components, modules, or mechanisms. Such components are tangible entities (e.g., hardware) capable of performing specified operations and are configured or arranged in a certain manner. In an example, circuits are arranged (e.g., internally or with respect to external entities such as other circuits) in a specified manner as a module. In an example, the whole or part of one or more computer systems (e.g., a standalone, client or server computer system) or one or more hardware processors are configured by firmware or software (e.g., instructions, an application portion, or an application) as a component that operates to perform specified operations. In an example, the software resides on a machine readable medium. In an example, the software, when executed by the underlying hardware of the component, causes the hardware to perform the specified operations.

Accordingly, such components are understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the modules need not be instantiated at any one moment in time. For example, where the components comprise a general-purpose hardware processor configured using software, in some embodiments, the general-purpose hardware processor is configured as respective different components at different times. Software accordingly configures a hardware processor, for example, to constitute a particular component at one instance of time and to constitute a different component at a different instance of time.

Some embodiments are implemented fully or partially in software and/or firmware. This software and/or firmware takes the form of instructions contained in or on a non-transitory computer-readable storage medium, in at least some embodiments. Those instructions are then read and executed by one or more hardware processors to enable performance of the operations described herein, in at least some embodiments. The instructions are in any suitable form, such as but not limited to source code, compiled code, interpreted code, executable code, static code, dynamic code, and the like. Such a computer-readable medium includes any tangible non-transitory medium for storing information in a form readable by one or more computers, such as but not limited to read only memory (ROM); random access memory (RAM); magnetic disk storage media; optical storage media; flash memory, etc.

Various embodiments may be implemented fully or partially in software and/or firmware. This software and/or firmware may take the form of instructions contained in or on a non-transitory computer-readable storage medium. Those instructions are then read and executed by one or more processors to enable performance of the operations described herein. The instructions are in any suitable form, such as but not limited to source code, compiled code, interpreted code, executable code, static code, dynamic code, and the like. Such a computer-readable medium includes, in at least some embodiments, any tangible non-transitory medium for storing information in a form readable by one or more computers, such as but not limited to read only memory (ROM); random access memory (RAM); magnetic disk storage media; optical storage media; flash memory, etc.

### VARIOUS NOTES & EXAMPLES

Example 1 is a method of producing a dynamic budget projection for an intellectual property portfolio, the method comprising: receiving an intellectual property portfolio comprising one or more patent documents; aggregating upcoming costs associated with each of the patent documents to produce a preliminary budgeting report; dynamically filtering the aggregated costs in the preliminary budgeting report based on one or more parameters; and producing a budgeting projection based on the dynamically filtered aggregated costs.

In Example 2, the subject matter of Example 1 optionally includes wherein the patent documents comprise patents, patent applications, or both.

In Example 3, the subject matter of any one or more of Examples 1-2 optionally include wherein the upcoming costs associated with each of the patent documents comprises annuities, fees, attorney budgets, or other associated costs.

In Example 4, the subject matter of any one or more of Examples 1-3 optionally include wherein receiving an intellectual property portfolio comprises automatically scrapping information regarding the one or more patent documents from a database.

In Example 5, the subject matter of Example 4 optionally includes wherein the database is a governmental database.

In Example 6, the subject matter of any one or more of Examples 4-5 optionally include wherein the database is a private database.

In Example 7, the subject matter of any one or more of Examples 1-6 optionally include wherein aggregating upcoming costs comprises determining one or more tasks associated with each of the patent documents and assigning a cost value to each of the one or more tasks.

In Example 8, the subject matter of any one or more of Examples 6-7 optionally include wherein aggregating upcoming costs comprises associating costs to each task based on a look-up table.

In Example 9; the subject matter of any one or more of Examples 1-8 optionally include wherein the one or more parameters comprise deadlines.

In Example 10, the subject matter of any one or more of Examples 1-9 optionally, include wherein the one or more parameters comprise jurisdictions.

In Example 11, the subject matter of any one or more of Examples 1-10 optionally include wherein dynamically filtering the aggregated costs comprises adding or removing particular of the aggregated costs based on the one or more parameters.

In Example 12, the subject matter of any one or more of Examples 1-11 optionally include wherein producing a budgeting projection comprises producing a visual representation of the budgeting projection on a user interface.

Example 13 is a system comprising a processor and a memory, the processor configured to: receive an intellectual property portfolio comprising one or more patent documents; aggregate upcoming costs associated with each of the patent documents to produce a preliminary budgeting report; dynamically filter the aggregated costs in the preliminary budgeting report based on one or more parameters; and produce a budgeting projection based on the dynamically filtered aggregated costs.

In Example 14, the subject matter of Example 13 optionally includes wherein the patent documents comprise patents, patent applications, or both.

In Example 15, the subject matter of any one or more of Examples 13-14 optionally include wherein the upcoming costs associated with each of the patent documents comprises annuities, fees, attorney budgets, or other associated costs.

In Example 16, the subject matter of any one or more of Examples 13-15 optionally include wherein the processor configured to receive an intellectual property portfolio by automatically scrapping information regarding the one or more patent documents from a database.

In Example 17, the subject matter of any one or more of Examples 13-16 optionally include wherein the one or more parameters comprise deadlines.

In Example 18, the subject matter of any one or more of Examples 13-17 optionally include wherein the one or more parameters comprise jurisdictions.

In Example 19, the subject matter of any one or more of Examples 13-18 optionally include wherein the processor configured to dynamically filter the aggregated costs by adding or removing particular of the aggregated costs based on the one or more parameters.

In Example 20, the subject matter of any one or more of Examples 13-19 optionally include wherein the processor configured to aggregate upcoming costs by determining one or more tasks associated with each of the patent documents and assigning a cost value to each of the one or more tasks.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed:

1. A method of producing a dynamic budget projection for an intellectual property portfolio, the method comprising:
receiving an intellectual property portfolio comprising one or more patent documents;
aggregating upcoming costs associated with each of the patent documents to produce a preliminary budgeting report;
dynamically filtering the aggregated costs in the preliminary budgeting report based on one or more parameters; and
producing a budgeting projection based on the dynamically filtered aggregated costs.

2. The method of claim 1, wherein the patent documents comprise patents, pate applications, or both.

3. The method of claim 1, wherein the upcoming costs associated with each of the patent documents comprises annuities, fees; attorney budgets, or other associated costs.

4. The method of claim 1, wherein receiving an intellectual property portfolio comprises automatically scrapping information regarding the one or more patent documents from a database.

5. The method of claim 4, wherein the database is a governmental database.

6. The method of claim 4, wherein the database is a private database.

7. The method of claim 1, wherein aggregating upcoming costs comprises determining one or more tasks associated with each of the patent documents and assigning a cost value to each of the one or more tasks.

8. The method of claim 6, wherein aggregating upcoming costs comprises associating costs to each task based on a look-up table.

9. The method of claim 1, wherein the one or more parameters comprise deadlines.

10. The method of claim 1, wherein the one or more parameters comprise jurisdictions.

11. The method of claim 1, wherein dynamically filtering the aggregated costs comprises adding or removing particular of the aggregated costs based on the one or more parameters.

12. The method of claim 1, wherein producing a budgeting projection comprises producing a visual representation of the budgeting projection on a user interface.

13. A system comprising a processor and a memory, the processor configured to:
receive an intellectual property portfolio comprising one or more patent documents;
aggregate upcoming costs associated with each of the patent documents to produce a preliminary budgeting report;
dynamically filter the aggregated costs in the preliminary budgeting report based on one or more parameters; and
produce a budgeting projection based on the dynamically filtered aggregated costs.

14. The system of claim 13, wherein the patent documents comprise patents, patent applications, or both.

15. The system of claim 13, wherein the upcoming costs associated with each of the patent documents comprises annuities, fees, attorney budgets, or other associated costs.

16. The system of claim 13, wherein the processor configured to receive an intellectual property portfolio by automatically scrapping information regarding the one or more patent documents from a database.

17. The system of claim 13, wherein the processor configured to aggregate upcoming costs by determining one or more tasks associated with each of the patent documents and assigning a cost value to each of the one or more tasks.

18. The system of claim 13, wherein the one or more parameters comprise deadlines.

19. The system of claim 13, wherein the one or more parameters comprise jurisdictions.

20. The system of claim 13, wherein the processor configured to dynamically filter the aggregated costs by adding or removing particular of the aggregated costs based on the one or more parameters.
